(19) United States
(12) Patent Application Publication
(10) Pub. No.: US 2024/0196065 A1
(43) Pub. Date: Jun. 13, 2024

(54) INFORMATION PROCESSING APPARATUS AND INFORMATION PROCESSING METHOD

(71) Applicant: SONY GROUP CORPORATION, TOKYO (JP)

(72) Inventor: TOSHIYA HAMADA, TOKYO (JP)

(21) Appl. No.: 18/556,361

(22) PCT Filed: Jan. 17, 2022
(86) PCT No.: PCT/JP2022/001268

§ 371 Date: Oct. 20, 2023

(30) Foreign Application Priority Data
Apr. 28, 2021 (JP) 2021-076652

(51) Int. Cl. H04N 21/81; G06F 3/01; G06T 5/70; G06V 10/25; G06V 10/74; H04N 19/124

(52) U.S. Cl. CPC H04N 21/816; G06F 3/013; G06T 5/70; G06V 10/25; G06V 10/761; H04N 19/124

(57) ABSTRACT

An information processing apparatus includes a rendering section. The rendering section performs rendering processing on three-dimensional space data on the basis of field-of-view information regarding a field of view of a user to generate two-dimensional video data depending on the field of view of the user. Further, the rendering section sets a region of interest and a region of non-interest in a display region in which the two-dimensional video data is displayed, the region of interest being to be rendered at a high resolution, the region of non-interest being to be rendered at a low resolution; extracts a gaze object at which the user gazes, on the basis of a parameter related to the rendering processing and the field-of-view information; renders the gaze object in the region of interest at a high resolution; and reduces a data amount of a non-gaze object that is an object other than the gaze object in the region of interest.

### TECHNICAL FIELD

The present technology relates to an information processing apparatus and an information processing method that can be applied to, for example, the distribution of virtual-reality (VR) videos.

### BACKGROUND ART

In recent years, 360-degree-all-direction videos captured by, for example, 360-degree-all-direction cameras and viewed in all directions, have been increasingly distributed. Further, recently, a technology used to distribute six-degrees-of-freedom (DoF) videos (also referred to as 6-DoF content) that enable viewers (users) to view in all directions (to freely select a direction of a line of sight), and to freely move in a three-dimensional space (to freely select a position of a viewpoint) has been under development.

In such 6-DoF content, a three-dimensional space with at least one three-dimensional object is dynamically reproduced for each time according to a position of a viewpoint of a viewer, a direction of a line of sight of the viewer, and a viewing angle (a field of view) of the viewer.

In such video distribution, there is a need to dynamically adjust (render), according to a field of view of a viewer, video data to be provided to the viewer. For example, the technology disclosed in Patent Literature 1 is an example of such a technology.

### CITATION LIST

### Patent Literature

Patent Literature 1: Japanese Unexamined Patent Application Publication No. 2007-520925

### DISCLOSURE OF INVENTION

### Technical Problem

The distribution of virtual videos such as VR videos is expected to become more prevailing, and thus there is a need for a technology that makes it possible to distribute high-quality virtual videos.

In view of the circumstances described above, it is an object of the present technology to provide an information processing apparatus and an information processing method that make it possible to distribute high-quality virtual videos.

### Solution to Problem

In order to achieve the object described above, an information processing apparatus according to an embodiment of the present technology includes a rendering section.

The rendering section performs rendering processing on three-dimensional space data on the basis of field-of-view information regarding a field of view of a user to generate two-dimensional video data depending on the field of view of the user.

Further, the rendering section sets a region of interest and a region of non-interest in a display region in which the two-dimensional video data is displayed, the region of interest being to be rendered at a high resolution, the region of non-interest being to be rendered at a low resolution; extracts a gaze object at which the user gazes, on the basis of a parameter related to the rendering processing and the field-of-view information; renders the gaze object in the region of interest at a high resolution; and reduces a data amount of a non-gaze object that is an object other than the gaze object in the region of interest.

In the information processing apparatus, a region of interest and a region of non-interest are set in a display region in which rendering-target two-dimensional video data is displayed. Then, a gaze object in the region of interest is rendered at a high resolution, and a data amount of a non-gaze object in the region of interest is reduced. This makes it possible to distribute a high-quality virtual video.

The parameter related to the rendering processing may include distance information regarding a distance to a rendering-target object. In this case, the rendering section may reduce the data amount of the non-gaze object in the region of interest on the basis of the distance information.

The rendering section may perform blurring processing on the non-gaze object in the region of interest.

The rendering section may simulate a blur based on a depth of field of a lens in a real world to perform the blurring processing.

The rendering section may set a higher blurring intensity for the non-gaze object when a difference between a distance to the non-gaze object and a specified reference distance becomes larger.

The rendering section may set a plurality of ranges for a difference between a distance to the non-gaze object and a specified reference distance, and may set a blurring intensity for each of the plurality of ranges.

The rendering section may set a first range in which the difference between the distance to the non-gaze object and the specified reference distance is between zero and a first distance, may set a second range in which the difference is between the first distance and a second distance that is larger than the first distance, may set a first blurring intensity for the first range, and may set, for the second range, a second blurring intensity that is higher than the first blurring intensity.

The rendering section may set a third range in which the difference is between the second distance and a third distance that is larger than the second distance, and may set, for the third range, a third blurring intensity that is higher than the second blurring intensity.

The rendering section may set the blurring intensity such that the non-gaze object situated in a range situated farther away from the user than a location at a specified reference distance is more blurred than the non-gaze object situated in a range situated closer to the user than the location at the reference distance.

The rendering section may perform the blurring processing on the non-gaze object after the rendering section renders the non-gaze object at a high resolution.

The rendering section may render the non-gaze object at a resolution to be applied when the blurring processing is performed.

When a portion of the gaze object is situated in the region of non-interest, the rendering section may render the portion of the gaze object in the region of non-interest at a high resolution.

The rendering section may render the gaze object in the region of interest at a first resolution, and may render, at a second resolution, the non-gaze object that is an object other than the gaze object in the region of interest, the second resolution being lower than the first resolution.

The rendering section may set the region of interest and the region of non-interest on the basis of the field-of-view information.

The information processing apparatus may further include an encoding section that sets a quantization parameter for the two-dimensional video data and performs encoding processing on the two-dimensional video data on the basis of the set quantization parameter.

The encoding section may set a first quantization parameter for the region of interest, and may set, for the region of non-interest, a second quantization parameter that exhibits a larger value than the first quantization parameter.

The encoding section may set a first quantization parameter for the gaze object in the region of interest, may set, for the non-gaze object in the region of interest, a second quantization parameter that exhibits a larger value than the first quantization parameter, and may set, for the region of non-interest, a third quantization parameter that exhibits a larger value than the second quantization parameter.

The three-dimensional space data may include at least one of 360-degree-all-direction video data or space video data.

An information processing method according to an embodiment of the present technology is an information processing method that is performed by a computer system, the information processing method including performing rendering that is performing rendering processing on three-dimensional space data on the basis of field-of-view information regarding a field of view of a user to generate two-dimensional video data depending on the field of view of the user.

The performing rendering includes setting a region of interest and a region of non-interest in a display region in which the two-dimensional video data is displayed, the region of interest being to be rendered at a high resolution, the region of non-interest being to be rendered at a low resolution; extracting a gaze object at which the user gazes, on the basis of a parameter related to the rendering processing and the field-of-view information; rendering the gaze object in the region of interest at a high resolution; and reducing a data amount of a non-gaze object that is an object other than the gaze object in the region of interest.

### BRIEF DESCRIPTION OF DRAWINGS

FIG. 1 schematically illustrates an example of a basic configuration of a server-side rendering system.

FIG. 2 is a schematic diagram used to describe an example of a virtual video that can be viewed by a user.

FIG. 3 is a schematic diagram used to describe rendering processing.

FIG. 4 schematically illustrates an example of a functional configuration of the server-side rendering system.

FIG. 5 is a flowchart illustrating an example of a basic operation of rendering.

FIG. 6 is a schematic diagram used to describe an example of foveated rendering.

FIG. 7 is a schematic diagram used to describe an example of rendering information.

FIG. 8 schematically illustrates a specific example of configurations of a rendering section and an encoding section that are illustrated in FIG. 4.

FIG. 9 is a flowchart illustrating an example of generating a rendering video.

FIG. 10 is a schematic diagram used to describe the processes of Steps illustrated in FIG. 9.

FIG. 11 is a schematic diagram used to describe the processes of Steps illustrated in FIG. 9.

FIG. 12 is a schematic diagram used to describe the processes of Steps illustrated in FIG. 9.

FIG. 13 is a schematic diagram used to describe the processes of Steps illustrated in FIG. 9.

FIG. 14 is a schematic diagram used to describe the processes of Steps illustrated in FIG. 9.

FIG. 15 is a schematic diagram used to describe the processes of Steps illustrated in FIG. 9.

FIG. 16 is a schematic diagram used to describe blurring processing using a depth map.

FIG. 17 is a schematic diagram used to describe the blurring processing using a depth map.

FIG. 18 schematically illustrates an example of rendering according to another embodiment.

FIG. 19 is a block diagram illustrating an example of a hardware configuration of a computer (an information processing apparatus) by which a server apparatus and a client apparatus can be implemented.

### MODE(S) FOR CARRYING OUT THE INVENTION

Embodiments according to the present technology will now be described below with reference to the drawings.

### [Server-Side Rendering System]

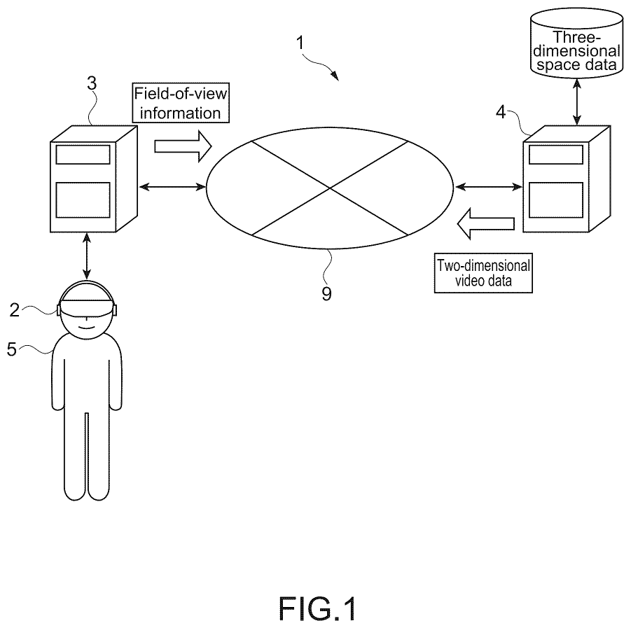

A server-side rendering system is configured as an embodiment according to the present technology. First, an example of a basic configuration and an example of a basic operation of a server-side rendering system is described with reference to FIGS. 1 to 3.

FIG. 1 schematically illustrates an example of the basic configuration of the server-side rendering system.

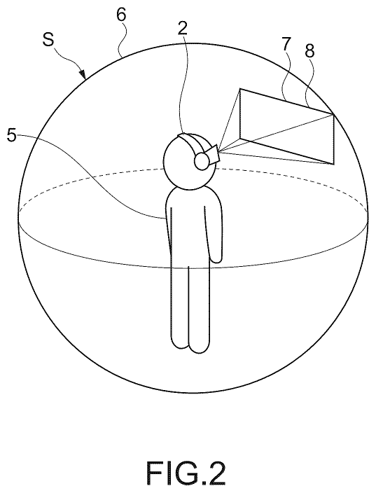

FIG. 2 is a schematic diagram used to describe an example of a virtual video that can be viewed by a user.

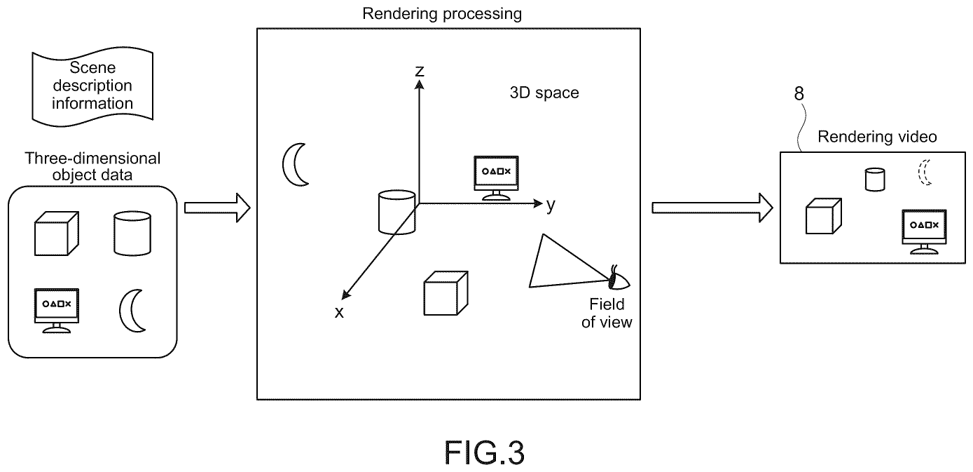

FIG. 3 is a schematic diagram used to describe rendering processing.

Note that the server-side rendering system can also be referred to as a server-rendering media distribution system.

As illustrated in FIG. 1, a server-side rendering system 1 includes a head-mounted display (HMD) 2, a client apparatus 3, and a server apparatus 4.

The HMD 2 is a device used to display a virtual video to a user 5. The HMD 2 is used by being worn on a head of the user 5.

For example, when a VR video is distributed as a virtual video, the HMD 2 of an immersive type, which is configured to cover a field of view of the user 5, is used.

When an augmented reality (AR) video is distributed as a virtual video, AR glasses or the like are used as the HMD 2.

A device other than the HMD 2 may be used as a device used to provide a virtual video to the user 5. For example, a virtual video can be displayed on a display provided to a television, a smartphone, a tablet terminal, or a personal computer (PC).

In the present embodiment, a full 360-degree spherical video 6 is provided as a VR video to the user 5 wearing the immersive HMD 2, as illustrated in FIG. 2. Further, the full 360-degree spherical video 6 is provided to the user 5 as a 6-DoF video.

In a virtual space S that is a three-dimensional space, the user 5 can view a video in a range of 360 degrees in all directions from back and forth, from side to side, and up and down. For example, the user 5 freely moves, for example, a position of his/her viewpoint and a direction of his/her line of sight in the virtual space S to freely change his/her own field of view 7. In response to the change in the field of view 7 of the user 5, videos 8 displayed to the user 5 are switched. The user 5 performs a motion such as turning his/her head, inclining his/her head, or turning, and this enables the user 5 to view a surrounding region in the virtual space S as if the user 5 were in a real world.

As described above, the server-side rendering system 1 according to the present embodiment makes it possible to distribute a free-viewpoint photorealistic video, and to thus provide an experience in viewing at a position of a free viewpoint.

In the present embodiment, the HMD 2 acquires field-of-view information, as illustrated in FIG. 1.

The field-of-view information is information regarding the field of view 7 of the user 5. Specifically, the field-of-view information includes any information that makes it possible to specify the field of view 7 of the user 5 in the virtual space S. Examples of the field-of-view information include a position of a viewpoint, a direction of a line of sight, and an angle of rotation of the line of sight. The examples of the field-of-view information further include a position of a head of the user 5 and an angle of turning of the head of the user 5. The position of a head of a user and the angle of turning of the head of the user can also be referred to as head-motion information.

For example, the angle of rotation of a line of sight can be defined by an angle of rotation about a rotational axis that extends in parallel with the line of sight. Further, the angle of turning of the head of the user 5 can be defined by a roll angle, a pitch angle, and a yaw angle that are obtained when three axes that are set with respect to the head and orthogonal to each other are a roll axis, a pitch axis, and a yaw axis.

For example, an axis that extends in a front direction in which the face faces is defined as a roll axis. An axis that extends in a right-and-left direction when the face of the user 5 is viewed from the front is defined as a pitch axis, and an axis that extends in an up-and-down direction when the face of the user 5 is viewed from the front is defined as a yaw axis. A roll angle, a pitch angle, and a yaw angle that are respectively obtained with respect to the roll axis, the pitch axis, and the yaw axis are calculated as an angle of turning of a head. Note that a direction of the roll axis can also be used as a direction of a line of sight.

Moreover, any information that makes it possible to specify the field of view of the user 5 may be used. One of the pieces of information described above as examples may be used as field-of-view information, or a plurality of the pieces of information may be used in combination as the field-of-view information.

A method for acquiring field-of-view information is not limited. For example, the field-of-view information can be acquired on the basis of a result of detection (a result of sensing) performed by a sensor apparatus (including a camera) that is included in the HMD 2.

For example, the HMD 2 is provided with, for example, a camera or ranging sensor of which a detection range covers a region around the user 5, or inward-oriented cameras that can respectively capture an image of a right eye of the user 5 and an image of a left eye of the user 5. Further, the HMD 2 is provided with an inertial measurement unit (IMU) sensor or a GPS.

For example, position information regarding a position of the HMD 2 that is acquired by a GPS can be used as a position of the viewpoint of the user 5 or a position of the head of the user 5. Of course, positions of the right and left eyes of the user 5, or the like may be calculated in more detail.

Further, a direction of a line of sight can be detected using captured images of the right and left eyes of the user 5.

Furthermore, an angle of rotation of a line of sight and an angle of turning of the head of the user 5 can be detected using a result of detection performed by an IMU.

Further, a self-location of the user 5 (the HMD 2) may be estimated on the basis of a result of detection performed by a sensor apparatus included in the HMD 2. For example, position information regarding a position of the HMD 2 and pose information regarding, for example, which direction the HMD 2 is oriented toward can be calculated by the self-location estimation. Field-of-view information can be acquired using the position information and the pose information.

An algorithm used to estimate a self-location of the HMD 2 is also not limited, and any algorithm such as simultaneous localization and mapping (SLAM) may be used.

Further, head tracking performed to detect a motion of the head of the user 5, or eye tracking performed to detect movement of right and left lines of sight of the user 5 may be performed.

Moreover, any device or any algorithm may be used in order to acquire field-of-view information. For example, when a smartphone or the like is used as a device used to display a virtual video to the user 5, an image of, for example, the face (the head) of the user 5 may be captured, and the field-of-view information may be acquired on the basis of the captured image.

Alternatively, a device that includes, for example, a camera or an IMU may be attached to the head of the user 5 or around the eyes of the user 5.

Any machine-learning algorithm using, for example, a deep neural network (DNN) may be used in order to generate the field-of-view information. The use of, for example, artificial intelligence (AI) performing deep learning makes it possible to improve the accuracy in generating the field-of-view information.

Note that a machine-learning algorithm can be applied to any processing performed in the present disclosure.

The HMD 2 and the client apparatus 3 are connected to be capable of communicating with each other. The type of communication used to connect both of the devices such that the devices are capable of communicating with each other is not limited, and any communication technology may be used. For example, wireless network communication using, for example, Wi-Fi or near field communication using, for example, Bluetooth (registered trademark) can be used.

The HMD 2 transmits the field-of-view information to the client apparatus 3.

Note that the HMD 2 and the client apparatus 3 may be integrated with each other. In other words, the HMD 2 includes a function of the client apparatus 3.

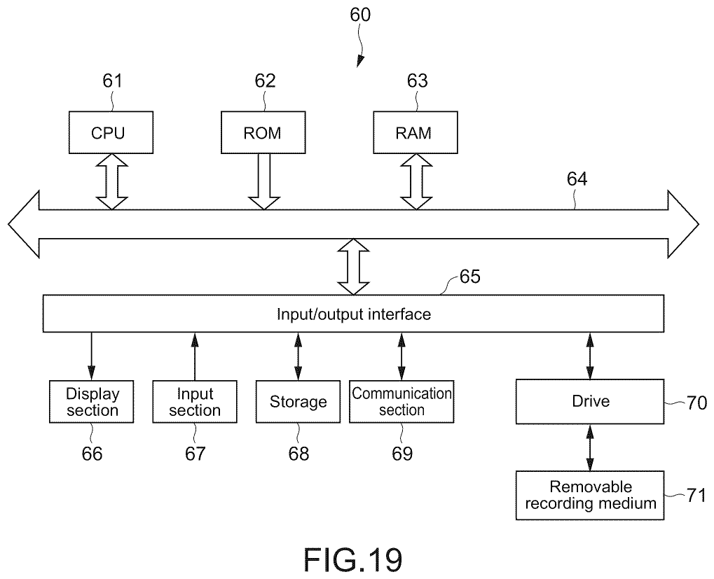

The client apparatus 3 and the server apparatus 4 each include hardware, such as a CPU, a ROM, a RAM, and an HDD, that is necessary for a configuration of a computer (refer to FIG. 19). An information processing method according to the present technology is performed by, for example, the CPU loading, into the RAM, a program according to the present technology that is recorded in, for example, the ROM in advance and executing the program.

For example, the client apparatus 3 and the server apparatus 4 can be implemented by any computers such as personal computers (PC). Of course, hardware such as an FPGA or an ASIC may be used.

Of course, the client apparatus 3 and the server apparatus 4 are not limited to having configurations identical to each other.

The client apparatus 3 and the server apparatus 4 are connected through a network 9 to be capable of communicating with each other.

The network 9 is built by, for example, the Internet or a wide area communication network. Moreover, for example, any wide area network (WAN) or any local area network (LAN) may be used, and a protocol used to build the network 9 is not limited.

The client apparatus 3 receives field-of-view information transmitted by the HMD 2. Further, the client apparatus 3 transmits the field-of-view information to the server apparatus 4 through the network 9.

The server apparatus 4 receives field-of-view information transmitted by the client apparatus 3. Further, on the basis of the field-of-view information, the server apparatus 4 performs rendering processing on three-dimensional space data to generate two-dimensional video data (a rendering video) depending on the field of view 7 of the user 5.

The server apparatus 4 corresponds to an embodiment of an information processing apparatus according to the present technology. An embodiment of the information processing method according to the present technology is performed by the server apparatus 4.

As illustrated in FIG. 3, the three-dimensional space data includes scene description information and three-dimensional object data.

The scene description information corresponds to three-dimensional-space-description data used to define a configuration of a three-dimensional space (a virtual space S). The scene description information includes various metadata, such as attribute information regarding an attribute of an object, that is used to reproduce each scene of 6-DoF content.

The three-dimensional object data is data used to define a three-dimensional object in a three-dimensional space. In other words, the three-dimensional object data is data of an object that forms a scene of 6-DoF content.

For example, data of three-dimensional objects of, for example, humans and animals, and data of three-dimensional objects of, for example, buildings and trees are stored. Alternatively, data of three-dimensional objects of, for example, the sky and the sea, which are included in, for example, a background is stored. A plurality of types of objects may be grouped as one three-dimensional object, and data of the one three-dimensional object may be stored.

The three-dimensional object data includes mesh data that can be represented in the form of polyhedron-shaped data, and texture data that is data attached to a face of the mesh data. Alternatively, the three-dimensional object data includes a collection of a plurality of points (a group of points) (point cloud).

On the basis of scene description information, the server apparatus 4 arranges a three-dimensional object in a three-dimensional space to reproduce the three-dimensional space, as illustrated in FIG. 3. The three-dimensional space is reproduced on a memory by computation being performed.

A video as viewed by the user 5 is captured on the basis of the reproduced three-dimensional space (rendering processing) to generate a rendering video that is a two-dimensional video to be viewed by the user 5.

The server apparatus 4 encodes the generated rendering video, and transmits the encoded rendering video to the client apparatus 3 through the network 9.

Note that a rendering video depending on the field of view 7 of a user can also be a video in a viewport (a display region) depending on the user.

The client apparatus 3 decodes the encoded rendering video transmitted by the server apparatus 4. Further, the client apparatus 3 transmits, to the HMD 2, the rendering video obtained by the decoding.

As illustrated in FIG. 2, a rendering video is played to be displayed to the user 5 by the HMD 2. A video 8 that is displayed to the user 5 by the HMD 2 may be hereinafter referred to as a rendering video 8.

### [Advantage of Server-Side Rendering System]

A client-side rendering system is another example of a system of distributing the full 360-degree spherical video 6 (a 6-DoF video) as illustrated in FIG. 2.

In the client-side rendering system, the client apparatus 3 performs rendering processing on three-dimensional space data on the basis of field-of-view information to generate two-dimensional video data (the rendering video 8). The client-side rendering system can also be referred to as a client-rendering media distribution system.

In the client-side rendering system, it is necessary that the server apparatus 4 transmit three-dimensional space data (three-dimensional-space-description data and three-dimensional object data) to the client apparatus 3.

The three-dimensional object data includes mesh data or group-of-points data (point cloud). Thus, a huge amount of distribution data is transmitted from the server apparatus 4 to the client apparatus 3. Further, it is necessary that the client apparatus 3 have a significantly great processing capability in order to perform rendering processing.

On the other hand, in the server-side rendering system 1 according to the present embodiment, the rendering video 8 after rendering is distributed to the client apparatus 3. This makes it possible to sufficiently reduce the amount of distribution data. In other words, this enables the user 5 to experience, with a smaller amount of distribution data, a 6-DoF video, in a large space, that includes a huge amount of three-dimensional object data. Further, processing burdens imposed on the client apparatus 3 can be unloaded onto the server apparatus 4. This also enables the user 5 to experience a 6-DoF video when the client apparatus 3 having a low processing capability is used.

Further, there is also a client-side-rendering distribution method including selecting, according to field-of-view information regarding a field of view of a user, an optimal piece of 3D object data from a plurality of pieces of 3D object data (for example, two kinds of pieces of data that are a piece of high-resolution data and a piece of low-resolution data) having different data sizes (qualities) and being provided in advance.

Comparison is performed with this distribution method. When the server-side rendering is applied, switching between pieces of 3D object data of two kinds of qualities is not performed even when there is a change in field of view. Thus, the server-side rendering provides an advantage in that seamless playback can be performed even when there is a change in field of view.

Further, when the client-side rendering is applied, field-of-view information is not transmitted to the server apparatus 4. Thus, it is necessary that the client apparatus 3 perform processing such as blurring on a specified region in the rendering video 8 if needed. In this case, 3D object data before blurring is transmitted to the client apparatus 3. This still results in difficulty in reducing an amount of distribution data.

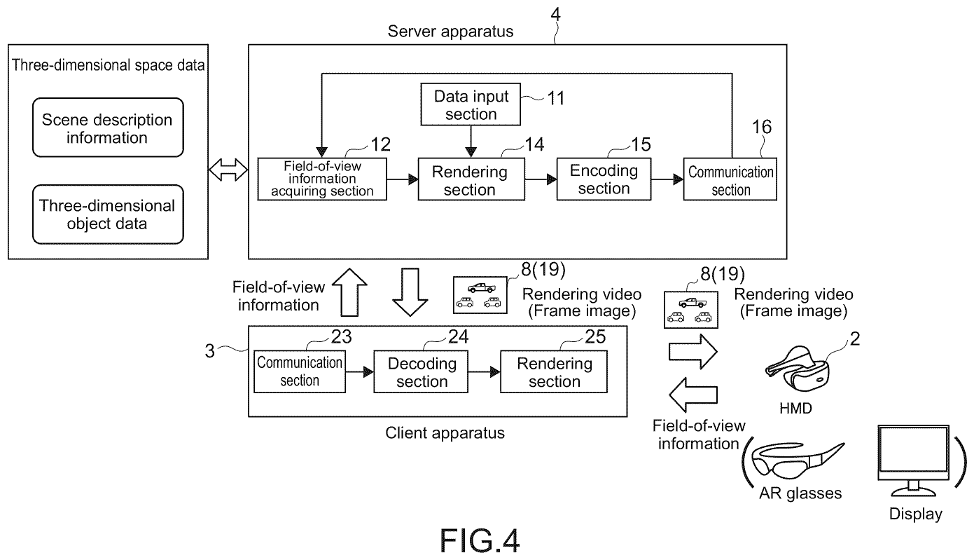

FIG. 4 schematically illustrates an example of a functional configuration of the server-side rendering system 1.

The HMD 2 acquires field-of-view information regarding the field of view of the user 5 in real time.

For example, the HMD 2 acquires the field-of-view information at a specified frame rate, and transmits the acquired field-of-view information to the client apparatus 3. Likewise, the client apparatus 3 transmits the field-of-view information repeatedly to the server apparatus 4 at a specified frame rate.

The frame rate at which field-of-view information is acquired (the number of times that field-of-view information is acquired per second) is set to be, for example, synchronized with a frame rate of the rendering video 8.

For example, the rendering video 8 is formed of a plurality of chronologically subsequent frame images. Each frame image is generated at a specified frame rate. The frame rate at which field-of-view information is acquired is set to be synchronized with the above-described frame rate of the rendering video 8. Of course, the configuration is not limited thereto.

Further, AR glasses or a display may be used as a device used to display a virtual video to the user 5, as described above.

The server apparatus 4 includes a data input section 11, a field-of-view information acquiring section 12, a rendering section 14, an encoding section 15, and a communication section 16.

These functional blocks are implemented by, for example, a CPU executing a program according to the present technology, and the information processing method according to the present embodiment is performed. Note that, in order to implement each functional block, dedicated hardware such as an integrated circuit (IC) may be used as appropriate.

The data input section 11 reads three-dimensional space data (scene description information and three-dimensional object data), and outputs the read three-dimensional space data to the rendering section 14.

Note that the three-dimensional space data is stored in, for example, a storage 68 (refer to FIG. 19) in the server apparatus 4. Alternatively, the three-dimensional space data may be managed by, for example, a content server that is connected to the server apparatus 4 to be capable of communicating with the server apparatus 4. In this case, the data input section 11 accesses the content server to acquire the three-dimensional space data.

The communication section 16 is a module used to perform, for example, network communication or near field communication with another device. For example, a wireless LAN module such as Wi-Fi, or a communication module such as Bluetooth (registered trademark) is provided.

In the present embodiment, communication with the client apparatus 3 through the network 9 is performed by the communication section 16.

The field-of-view information acquiring section 12 acquires field-of-view information from the client apparatus 3 through the communication section 16. The acquired field-of-view information may be recorded in, for example, the storage 68 (refer to FIG. 19). For example, a buffer or the like used to record the field-of-view information may be provided.

The rendering section 14 performs rendering processing, as illustrated in FIG. 3. In other words, rendering processing is performed on three-dimensional space data on the basis of field-of-view information acquired in real time to generate the rendering video 8 depending on the field of view 7 of the user 5.

In the present embodiment, a frame image 19 that forms the rendering video 8 is generated in real time on the basis of field-of-view information acquired at a specified frame rate.

The encoding section 15 performs encoding processing (compression coding) on the rendering video 8 (the frame image 19) to generate distribution data. The distribution data is packetized by the communication section 16 to be transmitted to the client apparatus 3.

This makes it possible to distribute the frame image 19 in real time in response to field-of-view information acquired in real time.

In the present embodiment, the rendering section 14 serves as an embodiment of a rendering section according to the present technology. The encoding section 15 serves as an embodiment of an encoding section according to the present technology.

The client apparatus 3 includes a communication section 23, a decoding section 24, and a rendering section 25.

These functional blocks are implemented by, for example a CPU executing the program according to the present technology, and the information processing method according to the present embodiment is performed. Note that, in order to implement each functional block, dedicated hardware such as an integrated circuit (IC) may be used as appropriate.

The communication section 23 is a module used to perform, for example, network communication or near field communication with another device. For example, a wireless LAN module such as Wi-Fi, or a communication module such as Bluetooth (registered trademark) is provided.

The decoding section 24 performs decoding processing on distribution data. This results in decoding the encoded rendering video 8 (frame image 19).

The rendering section 25 performs rendering processing such that the rendering video 8 (the frame image 19) obtained by the decoding can be displayed by the HMD 2.

The rendered frame image 19 is transmitted to the HMD 2 to be displayed to the user 5. This makes it possible to display the frame image 19 in real time in response to a change in the field of view 7 of the user 5.

### Example of Basic Operation of Rendering According to Present Technology

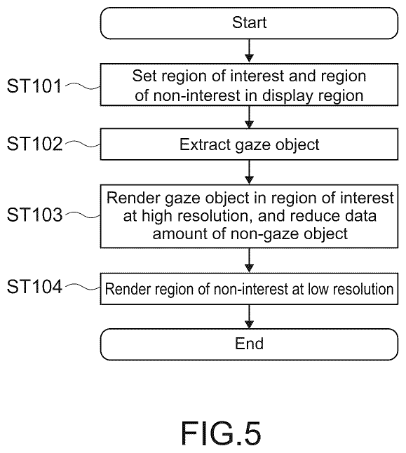

The inventors have held numerous discussions in order to distribute a high-quality virtual image using the server-side rendering system 1. In particular, numerous discussions have been held on two points that are “rendering processing burdens” and a “degradation in image quality due to real-time encoding”. Consequently, the inventors have newly devised rendering in which processing illustrated in FIG. 5 is an example of a basic operation of the rendering. The processing illustrated in FIG. 5 is performed by the rendering section 14.

In Step 101, a region of interest and a region of non-interest are set in a display region in which two-dimensional video data (the frame image 19) is displayed.

The display region in which the frame image 19 is displayed is a viewport depending on the field of view 7 of the user 5, and corresponds to an image region for the frame image 19 to be rendered. The display region in which the frame image 19 is displayed is also a region of a rendering target, and can also be a rendering-target region or a rendering region.

The region of interest is a region to be rendered at a high resolution. The region of non-interest is a region of non-interest to be rendered at a low resolution.

Note that the resolution (the number of pixels of V×H) of a frame image to be rendered remains unchanged. In the present disclosure, the expression of “being rendered at a high resolution” is used when an image to be rendered has a relatively higher resolution than a certain region (a pixel region). Further, the expression of “being rendered at a low resolution” is used when an image to be rendered has a relatively lower resolution than a certain region (a pixel region).

For example, when rendering is performed such that different pixel values (gradation values) are set for respective pixels of the frame image 19, an image will be rendered at a resolution of the frame image 19. On the other hand, when rendering is performed such that the same pixel value is set for pixels of a plurality of (for example, four) pixels put into a group, an image will be rendered at a lower resolution than the frame image 19.

For example, a region of interest to be rendered at a high resolution can be set to be a region to be rendered at the resolution of the frame image 19. Further, a region of non-interest to be rendered at a low resolution can be set to be a region to be rendered at a resolution lower than the resolution of the frame image 19. Of course, the settings are not limited to such settings.

The resolution of an image to be rendered may be hereinafter referred to as a rendering resolution.

In the present embodiment, foveated rendering is performed in order to perform the process of Step 101. The foveated rendering is also referred to as fovea rendering.

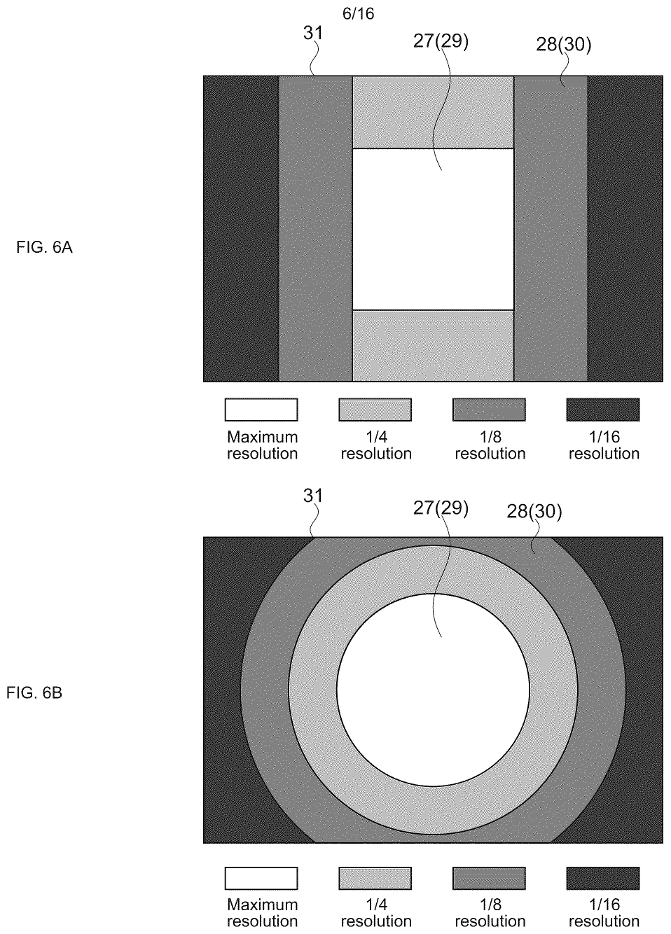

FIG. 6 is a schematic diagram used to describe an example of foveated rendering.

Foveated rendering is rendering performed according to human visual characteristics, where the resolution is high in a center portion of the field of view and is lower in a portion situated closer to an edge of the field of view.

For example, a field-of-view center region 27 that is obtained by partitioning the field of view to be rectangular or circular is rendered at a high resolution, as illustrated in A and B of FIG. 6. Further, a surrounding region 28 that surrounds the field-of-view center region 27 is partitioned into rectangular or circular regions, and the obtained regions are rendered at a low resolution.

In the examples illustrated in A and B of FIG. 6, the field-of-view center region 27 is rendered at a maximum resolution. For example, rendering is performed at the resolution of the frame image 19.

The surrounding region 28 is divided into three regions, and a region situated closer to an edge of the field of view is rendered at a lower resolution, that is, the three regions are respectively rendered at a resolution that is one quarter of the maximum resolution, a resolution that is one eighth of the maximum resolution, and a resolution that is one sixteenth of the maximum resolution.

In the examples illustrated in A and B of FIG. 6, the field-of-view center region 27 is set to be a region 29 of interest. Further, the surrounding region 28 is set to be a region 30 of non-interest. The region 30 of non-interest may be divided into a plurality of regions, and a rendering resolution may be gradually reduced, as illustrated in A and B of FIG. 6.

As described above, when foveated rendering is applied, a rendering resolution is set according to a two-dimensional location in a viewport (a display region) 31.

Note that positions of the field-of-view center region 27 (the region 29 of interest) and the surrounding region 28 (the region 30 of non-interest) are fixed in the examples illustrated in A and B of FIG. 6. Such foveated rendering is also referred to as fixed foveated rendering.

Without being limited thereto, the region 29 of interest being rendered at a high resolution may be dynamically set on the basis of a gaze point at which the user 5 is gazing. A region that surrounds the set region 29 of interest is the region 30 of non-interest being rendered at a low resolution.

Note that the gaze point of the user 5 can be calculated on the basis of field-of-view information regarding the field of view of the user 5. For example, the gaze point can be calculated on the basis of, for example, a direction of a line of sight or head-motion information. Of course, the gaze point itself is included in the field-of-view information. In other words, the gaze point may be used as the field-of-view information.

As described above, the region 29 of interest and the region 30 of non-interest may be dynamically set on the basis of field-of-view information regarding the field of view of the user 5.

In Step 102, a gaze object is extracted.

The gaze object is an object, from among rendering-target objects, at which the user 5 gazes.

For example, an object at which a gaze point of the user 5 is situated, is extracted as a gaze object. Alternatively, an object situated in a center portion of the viewport 31 may be extracted as a gaze object.

In most cases, at least a portion of the gaze object is situated in the region 29 of interest set by foveated rendering. Note that a condition that at least a portion of an object is situated in the region 29 of interest may be set to be a determination condition used to determine whether the object corresponds to the gaze object.

The gaze object is extracted on the basis of a parameter related to rendering processing and field-of-view information.

The parameter related to rendering processing includes any information used to generate the rendering video 8. Further, the parameter related to rendering processing includes any information that can be generated using information used to generate the rendering video 8.

For example, the parameter related to rendering processing is generated by the rendering section 14 on the basis of three-dimensional space data and field-of-view information. Of course, the present technology is not limited to such a generation method.

The parameter related to rendering processing may be hereinafter referred to as rendering information.

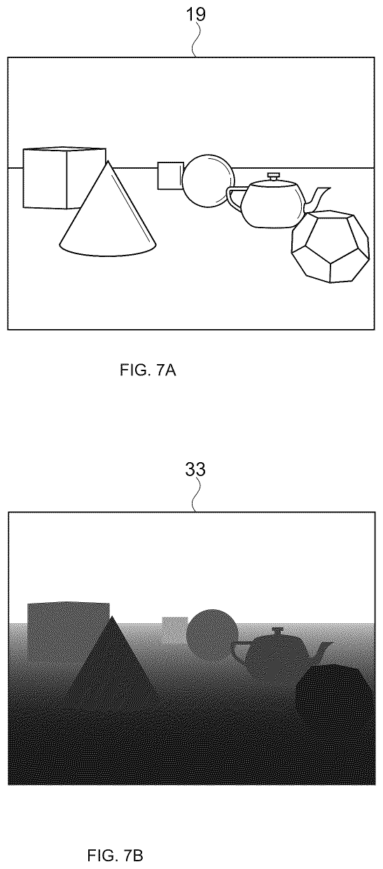

FIG. 7 is a schematic diagram used to describe an example of rendering information.

A of FIG. 7 schematically illustrates the frame image 19 generated by rendering processing. B of FIG. 7 schematically illustrates a depth map (a depth-map image) 33 that corresponds to the frame image 19.

The depth map 33 can be used as rendering information. The depth map 33 is data that includes distance information regarding a distance to a rendering-target object (depth information). The depth map 33 can also be referred to as a depth-information map or a distance-information map.

For example, image data obtained by transforming a distance to brightness can be used as the depth map 33. Of course, the present technology is not limited to such a manner.

The depth map 33 can be generated on the basis of, for example, three-dimensional space data and field-of-view information.

For example, when 3D rendering is adopted, there is a need to confirm whether a certain rendering-target object is situated ahead of or behind rendered objects. In this case, a Z buffer is used.

The Z buffer is a buffer that temporarily stores therein depth information regarding a depth of a current rendering image (a resolution identical to a resolution of the rendering image).

When the rendering section 14 renders a certain object in a state in which another object has been already rendered with respect to a pixel corresponding to the certain object, the rendering section 14 confirms whether the certain object is situated ahead of or behind the other object. Then, for each pixel, the rendering section 14 determines that rendering is to be performed when the current object is situated ahead of the other object, or determines that rendering is not to be performed when the current object is not situated ahead of the other object.

The Z buffer is used for the confirmation. A depth value of a rendered object is written to a corresponding pixel, and confirmation is performed by referring to the depth value. Then, when confirmation is performed with respect to a certain pixel and rendering is newly performed with respect to the certain pixel, a depth value obtained by the newly performed rendering is set to perform an update.

In other words, at a timing at which rendering of the frame image 19 is completed, the rendering section 14 also holds data of a depth-map image of a corresponding frame.

Note that a method for acquiring the depth map 33 corresponding to rendering information is not limited, and any method may be adopted.

Moreover, various information, such as a movement-vector map that includes movement information regarding a movement of a rendering-target object, brightness information regarding a brightness of the rendering-target object, and color information regarding a color of the rendering-target object, can be acquired as rendering information.

It is desirable that, in Step 102, a shape and a contour of a gaze object be detected accurately to separate the gaze object from other objects (hereinafter referred to as non-gaze objects) with a high degree of accuracy.

There are various analysis technologies that are technologies used to recognize and separate an object in a full 360-degree spherical video 6 or a 2D video. For example, various technologies, such as basic shape recognition performed using a brightness distribution or an edge detection, that are used to recognize an object in an image have been proposed. However, such technologies result in imposing heavy processing burdens, and it is difficult to completely eliminate an error that occurs due to erroneous detection. Further, it is more difficult to analyze a video in real time in terms of processing burdens.

The depth-map image 33 as illustrated in B of FIG. 7, which is acquired as rendering information, does not exhibit a depth value estimated by performing, for example, image analysis on the frame image 19, but an accurate value obtained in a process of rendering.

In other words, in the server-side rendering system 1, the user 5 renders a 2D video viewed by the user 5. Thus, an accurate depth map 33 can be acquired without processing burdens imposed upon image analysis that corresponds to analyzing the 2D video after rendering.

The use of the depth map 33 makes it possible to detect whether one of objects arranged in a three-dimensional space (a virtual space) S is ahead of or behind another of the objects, and thus to accurately detect a shape and a contour of each of the objects.

In the present embodiment, a gaze object can be extracted with a very high degree of accuracy in Step 102 on the basis of the depth map 33 and field-of-view information. Note that three-dimensional object data may be used to extract a gaze object. This makes it possible to improve the accuracy in extracting a gaze object.

A shape and a contour of a gaze object can be accurately detected. This makes it possible to only set, for a necessary region, a range in which rendering at a high resolution is performed, and to reduce a data amount (an information amount) of the frame image 19.

In Step 103, a gaze object in the region 29 of interest is rendered at a high resolution. Further, a data amount of a non-gaze object that is an object other than the gaze object in the region 29 of interest is reduced.

For example, after the entirety of the region 29 of interest is rendered at a high resolution, data amount reducing processing performed to reduce a data amount may be performed on a non-gaze object. In other words, data amount reducing processing may be performed on a non-gaze object rendered at a high resolution.

Alternatively, a rendering resolution to be applied when the data amount reducing processing is performed on a non-gaze object, is calculated. Then, the non-gaze object may be rendered at the calculated rendering resolution.

Examples of the data amount reducing processing include any processing performed to reduce an amount of data of an image, such as blurring processing, a reduction in rendering resolution, grayscaling, a reduction in a gradation value of an image, and a transformation of a mode for displaying an image.

For example, the data amount reducing processing performed on a non-gaze object also includes rendering a non-gaze object in the region 29 of interest at a rendering resolution lower than a rendering resolution set for the region 29 of interest.

In Step 104, the region 30 of non-interest is rendered at a low resolution. Accordingly, the entirety of the frame image 19 is rendered.

Note that an order of performing the processes of Steps illustrated in FIG. 5 is not limited. Further, the processes of Steps illustrated in FIG. 5 is not limited to being performed in a chronological order, and a plurality of the processes of Steps from among the processes of Steps illustrated in FIG. 5 may be performed in parallel. For example, a processing order of setting the region 29 of interest and the region 30 of non-interest in Step 101, and extracting a gaze object in Step 102 may be reversed. Further, the processes of Steps 101 and 102 may be performed in parallel.

Further, a plurality of the processes of Steps from among the processes of Steps illustrated in FIG. 5 may be performed in an integrated manner. For example, a rendering resolution used to render a gaze object in the region 29 of interest, a rendering resolution used after data amount reducing processing is performed on a non-gaze object in the region 29 of interest, and a rendering resolution used to render the region 30 of non-interest are set respectively. Then, the entirety of the frame image 19 is rendered at the set rendering resolutions.

When such processing is performed, it can be said that the processes of Steps 103 and 104 are performed in an integrated manner.

When the frame image 19 is encoded, a region rendered at a high resolution has a large data amount. When encoding (compression coding) is performed at a constant compression rate, a bit rate after encoding is increased in proportion to a data amount of an image before compression.

Here, the bit rate can be decreased by increasing the compression rate applied upon encoding. However, the increase in compression rate provides a disadvantage in that a degradation in image quality that is caused due to compression will become more noticeable.

When the rendering according to the present embodiment illustrated in FIG. 5 is applied, a gaze object, in the region 29 of interest, at which the user 5 is gazing is rendered at a high resolution. On the other hand, a data amount of a non-gaze object in the region 29 of interest is reduced.

This makes it possible to reduce a substantial data amount of the frame image 19 to a necessary minimum without a loss in subjective image quality. This enables the encoding section 15 situated on the output side to decrease a substantial data compression rate without an increase in bit rate, and to suppress a degradation in image quality that is caused due to compression.

### [Operation of Generating Two-Dimensional Video Data (Rendering Video)]

An example of generating a rendering video when the rendering illustrated in FIG. 5 is applied, is described.

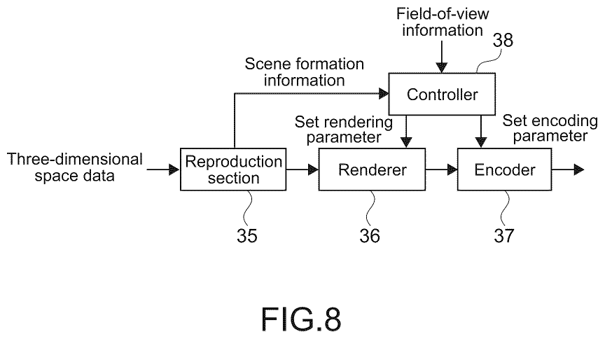

FIG. 8 schematically illustrates a specific example of respective configurations of the rendering section 14 and the encoding section 15 that are illustrated in FIG. 4.

In the present embodiment, a reproduction section 35, a renderer 36, an encoder 37, and a controller 38 are implemented in the server apparatus 4 as functional blocks.

These functional blocks are implemented by, for example, a CPU executing the program according to the present technology, and the information processing method according to the present embodiment is performed. Note that, in order to implement each functional block, dedicated hardware such as an integrated circuit (IC) may be used as appropriate.

On the basis of scene description information, the reproduction section 35 arranges a three-dimensional object to reproduce a three-dimensional space.

On the basis of the scene description information and field-of-view information, the controller 38 generates a rendering parameter used to give the renderer 36 instructions about how to perform rendering.

For example, the controller 38 specifies a region by foveated rendering, a gaze object, a rendering resolution, a parameter related to data amount reducing processing.

For example, a resolution map (a rendering resolution map) including a rendering resolution used to render a gaze object in the region 29 of interest, a rendering resolution used after data amount reducing processing is performed on a non-gaze object in the region 29 of interest, and a rendering resolution used to render the region 30 of non-interest can be used as rendering parameters.

Further, on the basis of the rendering parameter used to give the renderer 36 instructions, the controller 38 generates an encoding parameter used to give the encoder 37 instructions about how to perform encoding.

In the present embodiment, the controller 38 generates a QP map. The QP map corresponds to a quantization parameter set for two-dimensional video data.

For example, the quantization accuracy (a quantization parameter, QP) is changed for each region in the rendered frame image 19. This makes it possible to suppress a degradation in image quality that is caused due to a point of interest or an important region in the frame image 19 being compressed.

This makes it possible to suppress an increase in distribution data and processing burdens while maintaining a sufficient level of video quality with respect to a region important to the user 5. Note that, here, a QP value is a value that represents a quantization step size upon lossy compression. When the QP value is large, an encoding amount is decreased and the compression efficiency is increased. This results in further degrading in image quality due to compression. On the other hand, when the QP value is small, the encoding amount is increased and the compression efficiency is reduced. This makes it possible to suppress a degradation in image quality that is caused due to compression.

The renderer 36 performs rendering on the basis of a rendering parameter output by the controller 38. The encoder 37 performs encoding processing (compression coding) on two-dimensional video data on the basis of a QP map output by the controller 38.

In the example illustrated in FIG. 8, the rendering section 14 illustrated in FIG. 4 is implemented by the reproduction section 35, the controller 38, and the renderer 36. Further, the encoding section 15 illustrated in FIG. 4 is implemented by the controller 38 and the encoder 37.

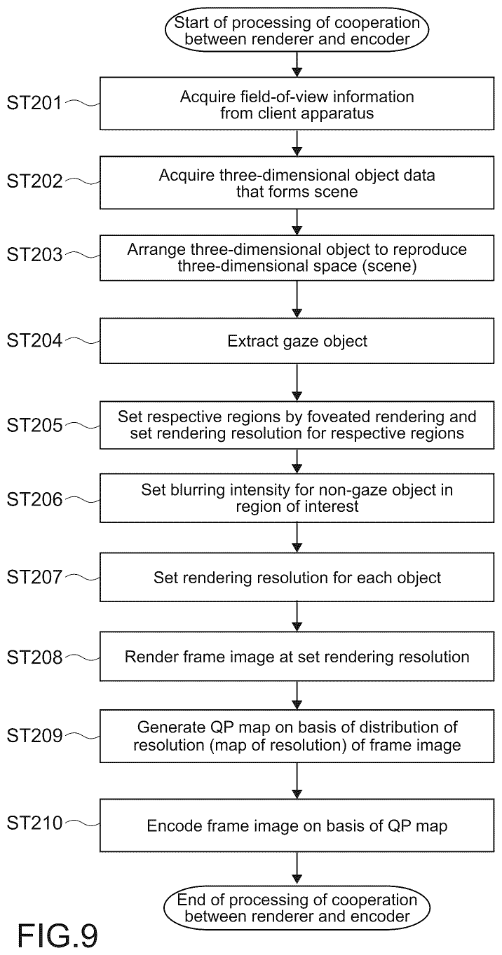

FIG. 9 is a flowchart illustrating an example of generating a rendering video. With reference to FIG. 9, an example of generation of the rendering video 8 (the frame image 19) that is performed by the server apparatus 4 is described as processing of cooperation between a renderer and an encoder.

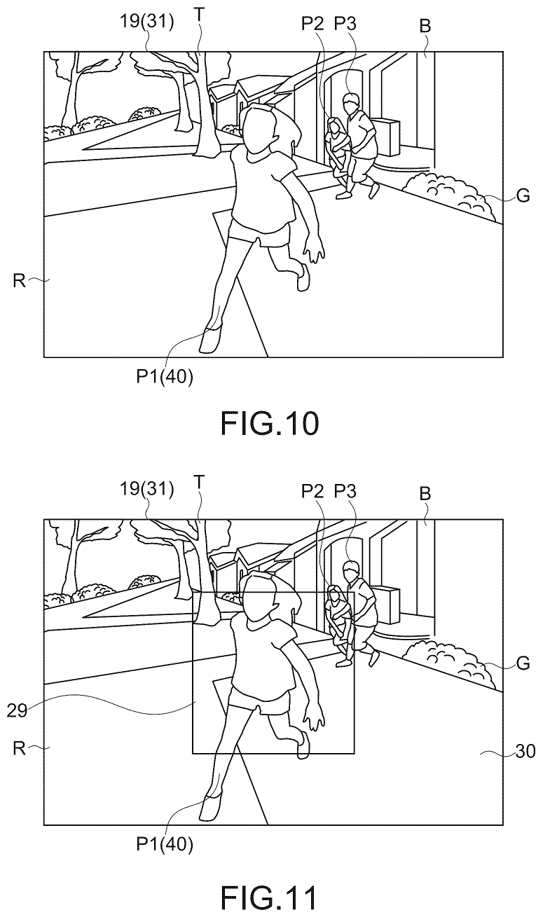

FIGS. 10 to 15 are schematic diagrams used to describe the processes of Steps illustrated in FIG. 9.

Here, an example of generating the frame image 19 of a scene illustrated in FIG. 10 is described.

In other words, it is assumed that the frame image 19 in which objects that are three persons P1 to P3, a tree T, a plant G, a road R, and a building B appear, is generated. Note that, actually, the trees of a plurality of the trees T in the frame image 19 are processed as objects different from each other and the plants of a plurality of the plants G in the frame image 19 are processed as objects different from each other, but the plurality of the trees T and the plurality of the plants G are respectively collectively referred to as the tree T and the plant G.

The communication section 16 acquires field-of-view information regarding the field of view of the user 5 from the client apparatus 3 (Step 201).

The data input section 11 acquires three-dimensional object data that forms a scene (Step 202). In the present embodiment, pieces of three-dimensional object data of the respective objects being illustrated in FIG. 10 and corresponding to the three persons P1 to P3, the tree T, the plant G, the road R, and the building B are acquired. The acquired pieces of three-dimensional object data are output to the reproduction section 35.

The reproduction section 35 arranges a three-dimensional object to reproduce a three-dimensional space (the scene) (Step 203). In the present embodiment, the pieces of three-dimensional object data of the respective objects being illustrated in FIG. 10 and corresponding to the three persons P1 to P3, the tree T, the plant G, the road R, and the building B are arranged to reproduce a three-dimensional space.

The controller 38 extracts a gaze object on the basis of the field-of-view information (Step 204). In the present embodiment, the person P1 in a center portion of the viewport (the display region) 31 is extracted as a gaze object 40. The process of Step 102 illustrated in FIG. 5 is performed by the above-described process of Step 204.

As illustrated in FIG. 11, the controller 38 sets respective regions by foveated rendering. In the present embodiment, the foveated rendering illustrated in A of FIG. 6 is performed. Thus, the field-of-view center region 27 is set to be the region 29 of interest, and the surrounding region 28 is set to be the region 30 of non-interest.

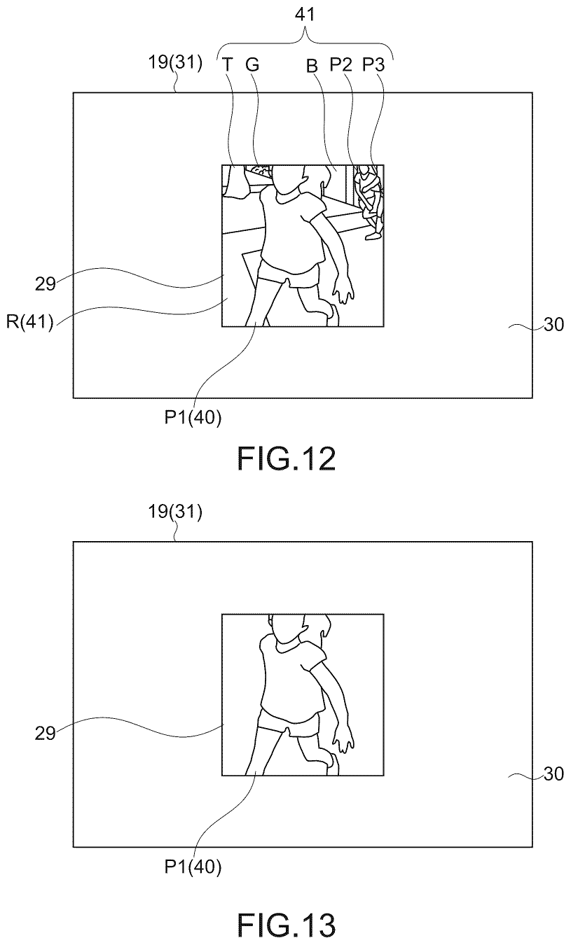

Note that, in FIG. 11, an illustration of partition performed to obtain regions of a plurality of regions in which the rendering resolution is gradually reduced in the region 30 of non-interest is omitted. The same applies to, for example, FIGS. 12 to 15.

The process of Step 101 illustrated in FIG. 5 is performed by the above-described process of Step 204.

The controller 38 sets a blurring intensity for a non-gaze object 41 in the region 29 of interest (Step 205).

In the present embodiment, a region that corresponds to a portion of the person P1 and is included in the region 29 of interest corresponds to the gaze object 40 in the region 29 of interest, as illustrated in FIGS. 12 to 14.

Further, regions that respectively correspond to portions of other objects (the persons P2 and P3, the tree T, the plant G, the road R, and the building B) and are included in the region 29 of interest each correspond to the non-gaze object 41 in the region 29 of interest. It can also be said that the non-gaze object 41 in the region 29 of interest corresponds to a region other than the region of the gaze object 40 in the region 29 of interest.

In the present embodiment, blurring processing is performed as data amount reducing processing performed on the non-gaze object 41 in the region 29 of interest.

In the present embodiment, setting of the same pixel value for pixels of a plurality of pixels put into a group is performed as the blurring processing. For example, pixel values of a plurality of grouped pixels are unified (for example, averaged) to calculate a pixel value to be set for the group. Thus, in the present embodiment, reduction of a rendering resolution is performed as the blurring processing.

A higher blurring intensity is set for a larger number of pixels grouped, and a lower blurring intensity is set for a smaller number of pixels grouped. Thus, the number of pixels grouped can be used as a parameter used to define the blurring intensity. Note that the blurring intensity is used as a parameter related to data amount reducing processing.

In the present embodiment, the blurring intensity is calculated on the basis of the depth map 33 illustrated in B of FIG. 7. In other words, the blurring intensity is set for the non-gaze object 41 on the basis of distance information regarding a distance to each object (depth information). The setting of a blurring intensity will be described in detail later.

When the reduction of a rendering resolution is performed as the data amount reducing processing, for example, the gaze object 40 in the region 29 of interest is rendered at a first resolution. The non-gaze object 41 that is an object other than the gaze object 40 in the region 29 of interest is rendered at a second resolution that is lower than the first resolution. Of course, data amount reducing processing other than the blurring processing may be performed as the reduction of a rendering resolution.

The controller 38 sets the rendering resolution for each object (Step 207).

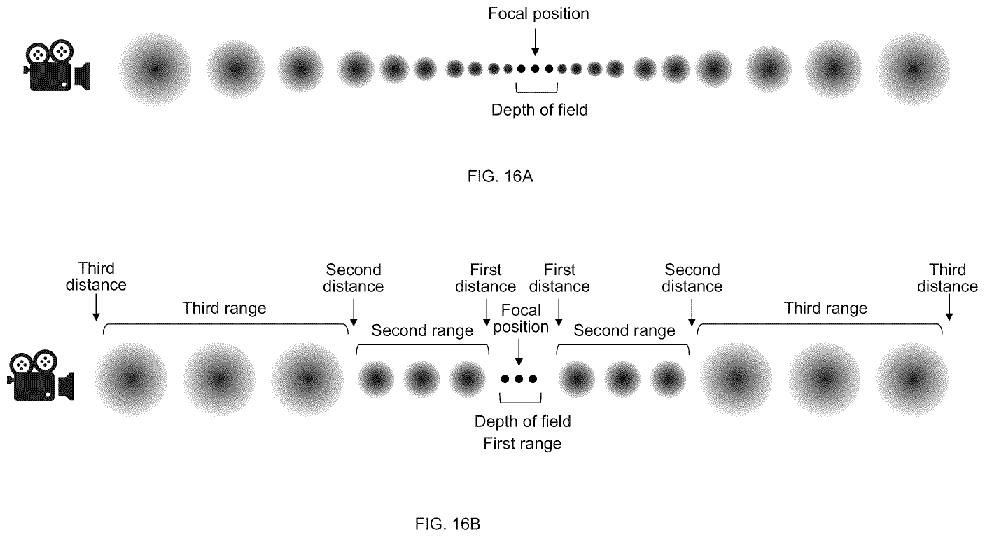

As illustrated in FIG. 15, the gradually reduced rendering resolution illustrated in A of FIG. 6 and applied to the surrounding region 28, is set for the objects (the persons P1 to P3, the tree T, the plant G, the road R, and the building B) in the region 30 of non-interest set by foveated rendering.

In other words, regions that respectively correspond to portions of the objects (the persons P1 to P3, the tree T, the plant G, the road R, and the building B) and are included in the region 30 of non-interest are rendered at a low resolution.

As illustrated in FIG. 13, the maximum resolution illustrated in A of FIG. 6 is set for the gaze object 40 (the person P1) in the region 29 of interest. In the present embodiment, the resolution of the frame image 19 is set.

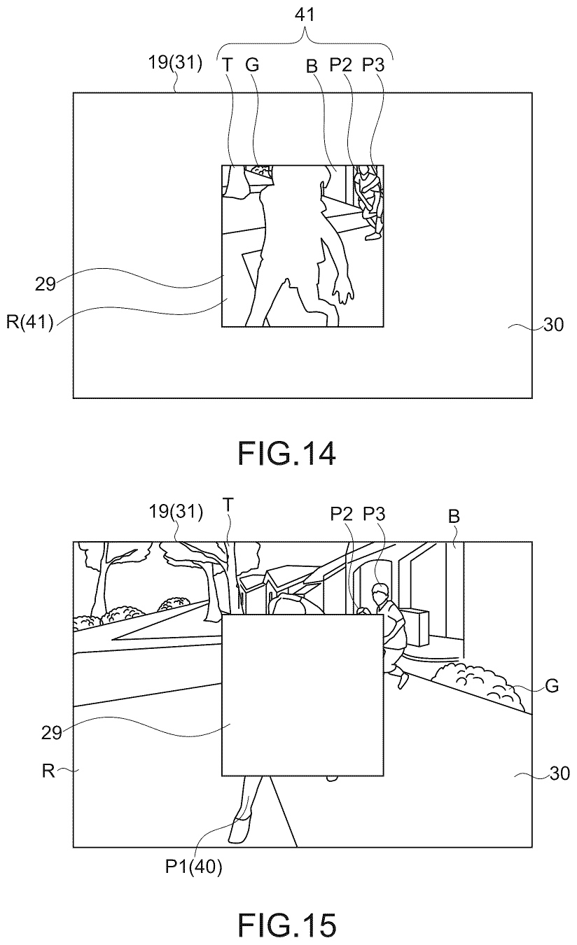

As illustrated in FIG. 14, a rendering resolution to be applied when the blurring processing is performed is set for the non-gaze object 41 in the region 29 of interest. For example, on the basis of image data (pixel data) when the non-gaze object 41 is rendered at the maximum resolution, a rendering resolution after the blurring processing is performed is calculated by computing. The calculated rendering resolution is set to be the rendering resolution for the non-gaze object 41.

Typically, the blurring intensity is set in Step 205 such that the rendering resolution after the blurring processing is higher than the resolution for the region 30 of non-interest. Of course, the setting is not limited thereto.

The renderer 36 renders the frame image 19 at the set rendering resolution (Step 208). The rendered frame image 19 is output to the encoder 37.

The controller 38 generates a QP map on the basis of a distribution of a resolution (a map of a resolution) of the frame image 19 (Step 209).

In the present embodiment, a QP map in which a low QP value is set for a high-resolution region and a high QP value is set for a low-resolution region, is generated.

For example, a first quantization parameter (QP value) is set for the region 29 of interest, and a second quantization parameter (QP value) that exhibits a larger value than the first quantization parameter (QP value) is set for the region 30 of non-interest.

Alternatively, a first quantization parameter (QP value) is set for the gaze object 40 in the region 29 of interest, a second quantization parameter (QP value) that exhibits a larger value than the first quantization parameter (QP value) is set for the non-gaze object 41 in the region 29 of interest, and a third quantization parameter (QP value) that exhibits a larger value than the second quantization parameter (QP value) is set for the region 30 of non-interest.

Moreover, any method may be adopted as a method for generating a QP map on the basis of a resolution map.

The encoder 37 performs encoding processing (compression coding) on the frame image 19 on the basis of the QP map (Step 210).

In the present embodiment, an encoding amount is large in a high-resolution region since a QP value is small in the high-resolution region. This results in low compression efficiency, and thus in being able to suppress a degradation in image quality that is caused due to compression. On the other hand, the encoding amount is small in a low-resolution region since the QP value is large in the low-resolution region. This results in high compression efficiency.

This results in suppressing an increase in distribution data and processing burdens while maintaining a level of video quality that is sufficient for the user 5, and, in addition, this is very advantageous in performing encoding processing in real time.

Further, in the present embodiment, a resolution map output by the rendering section 14 can be used. This results in there being no need to perform processing such as analysis of the frame image 19 that is performed by the encoding section 15. This results in reducing processing burdens imposed on the encoding section 15, and this is advantageous in performing encoding processing in real time.

In the processing illustrated in FIG. 9, the processes of Steps 103 and 104 illustrated in FIG. 5 are performed by the processes of Steps 205 to 208 in an integrated manner.

Further, in the processing illustrated in FIG. 9, blurring processing is performed together with rendering. This makes it possible to suppress rendering processing burdens.

Without being limited thereto, blurring processing may be performed on the rendered frame image 19 by use of, for example, filter processing.

### [Blurring Processing]

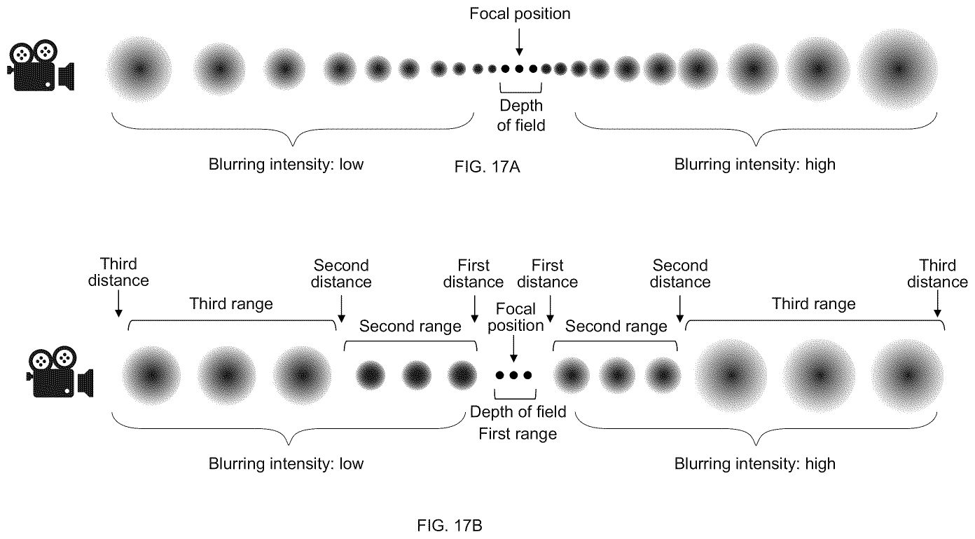

FIGS. 16 and 17 are schematic diagrams used to describe blurring processing using the depth map 33.

As illustrated in A of FIG. 16, blurring processing can be performed by simulating a blur based on a depth of field (DoF) of a lens in the real world. In other words, blurring processing is performed using a mechanism of a blur caused when an image of the real world is captured using a camera.

For example, a blurring intensity for the non-gaze object 41 is set by simulating a blur of a physical lens of which a depth of field is shallow.

In the simulation of a blur of a physical lens, the blur is successively increased at a location situated farther away from a focal position (a point of focus) backward or forward. In order to apply this to a 2D image, there is a need for information regarding whether one of objects is ahead of or behind another of the objects. Such information is not added to a general 2D image. Thus, it is difficult to determine the blurring intensity for each object.

In the present embodiment, the renderer 36 can generate a very accurate depth map 33. This makes it possible to easily calculate the blurring intensity with a high degree of accuracy.

In other words, the present embodiment also makes it possible not only to extract (separate) the gaze object 40 and the non-gaze object 41 with a high degree of accuracy, but also to perform blurring processing corresponding to data amount reducing processing with a high degree of accuracy on the basis of an accurate depth map 33, which is great characteristics of the present embodiment.

For example, a focal position is set for the non-gaze object 41 as a specified reference position. For example, a location of the gaze object 40 may be set to be the focal position.

As illustrated in A of FIG. 16, a higher blurring intensity is set for the non-gaze object 41 when a difference between a distance to the non-gaze object 41 and a distance to the focal position (a specified reference position) becomes larger.

In the example illustrated in A of FIG. 16, blurring intensities depending on the distance from the focal position are respectively set in the same mode (the same proportion) for a range situated closer to the user than the focal position and a range situated farther away from the user than the focal position. Thus, as illustrated in A of FIG. 16, the blurring intensity is symmetrically set with respect to the range situated closer to the user than the focal position and the range situated farther away from the user than the focal position.

Note that blurring processing is performed in order to reduce a data amount of the non-gaze object 41. Thus, in FIGS. 16 and 17, the blurring intensity is set such that a blur is also caused in the non-gaze object 41 within the depth of field. For example, a certain degree of blurring intensity may be set to be an offset value for the non-gaze object 41 within the depth of field. Alternatively, the blurring intensity may be set such that the blurring intensity is also increased within the depth of field according to the distance. This makes it possible to efficiently reduce a data amount of the non-gaze object 41.

Further, when most of the non-gaze objects 41 are situated at the same location as the gaze object 40, there is a possibility that the blurring intensity for the non-gaze object 41 will be reduced and a reduction in data amount will become smaller. In, for example, such a case, the focal position (a specified reference position) may be offset forwardly (in a direction of the gaze object 40) or backwardly (in a direction opposite to the gaze object 40) from the gaze object 40.

Various variations of setting of the blurring intensity depending on the distance are conceivable in order to further improve the efficiency in encoding performed by the encoder 37 situated on the output side.

First of all, in real-lens simulation, the non-gaze object 41 (in the region 29 of interest) situated at the same distance as the gaze object 40, as viewed from the user, comes into focus, and is to be rendered at a high resolution.

The purpose of blurring the non-gaze object 41 within the depth of field is not to perform real-lens simulation, but to improve the encoding efficiency. The blurring intensity does not necessarily have to be set along simulations based on parameters such as a focal length, an f-number, and a stop of a real lens.

In the example illustrated in B of FIG. 16, the blurring intensity is set for the non-gaze object 41 such that a blur caused at a certain distance from the focal position is greater than a blur expected to be caused at the certain distance.

For example, a plurality of ranges is set with respect to a difference between a distance to the non-gaze object 41 and a distance to the focal position (a specified reference distance). Then, the blurring intensity is set for each of the plurality of ranges.

In the example illustrated in B of FIG. 16, a first range in which a difference between a distance to the non-gaze object 41 and a specified reference distance is between zero and a first distance, and a second range in which the difference is between the first distance and a second distance that is larger than the first distance are set. In the example illustrated in B of FIG. 16, the first range corresponds to a range of the depth of field. Of course, the setting is not limited thereto.

A first blurring intensity is set for the first range, and a second blurring intensity that is higher than the first blurring intensity is set for the second range.

Further, in the example illustrated in B of FIG. 16, a third range in which the difference is between the second distance and a third distance that is larger than the second distance is set, and a third blurring intensity that is higher than the second blurring intensity is set for the third range.

Such blurring processing performed in a mode different from a mode applied to a real physical lens may be performed. In other words, the blurring intensity is set such that a blur is uniformly caused for the non-gaze objects 41 in one range.

This makes it possible to greatly reduce a data amount of the non-gaze object 41, and thus to more efficiently reduce a data amount of an image before being input to the encoder.

In the examples illustrated in A and B of FIG. 16, the blurring intensity is symmetrically set with respect to a range situated closer to the user than the focal position and a range situated further away than the focal position.

Without being limited thereto, the blurring intensity may be set in different modes for the range situated closer to the user than the focal position and the range situated further away than the focal position. In other words, the blurring intensity may be asymmetrically set with respect to the range situated closer to the user than the focal position and the range situated further away than the focal position.

In the examples illustrated in A and B of FIG. 17, the blurring setting is set such that the non-gaze object 41 situated in the range situated farther away from the user than the focal position is more blurred than the non-gaze object 41 situated in the range situated closer to the user than the focal position.

It is expected that the non-gaze object 41 situated at a smaller distance from the user 5 is more easily seen by the user 5. Thus, the blurring intensity is set such that the non-gaze object 41 situated in a range at a large distance from the user 5 is more blurred than the non-gaze object 41 situated in a range at a small distance from the user 5. This results in obtaining the frame image 19 easily viewed by the user 5.

Without being limited thereto, the blurring setting may be set such that the non-gaze object 41 situated in the range closer than the focal position is more blurred than the non-gaze object 41 situated in the range situated farther away from the user than the focal position.

Further, the setting in which the blurring intensity is gradually increased as a difference between a distance to the non-gaze object 41 and a distance to the focal position is increased, as illustrated in A of FIG. 16, and the setting in which differences between a distance to the non-gaze object 41 and a distance to the focal position are classified into ranges of a plurality of ranges, as illustrated in B of FIG. 16 may be used in combination.

For example, the setting of A of FIG. 16 is adopted for the range situated closer to the user than the focal position. The setting of B of FIG. 16 is adopted for the range situated farther away from the user than the focal position. Such settings of the blurring intensity may be adopted.

As data amount reducing processing performed on the non-gaze object 41, blurring processing may be performed on the entirety of the region 29 of interest including the gaze object 40. In this case, the gaze object 40 is assumed to be situated at the focal position (the blurring intensity is zero). Note that, when the gaze object 40 is long in depth, blurring processing such that the entirety of the gaze object 40 is in focus is performed.

Processing using a blurring filter such as an averaging filter may be performed as blurring processing. This blurring processing includes setting a circular kernel for a target pixel and transforming a pixel value of the target pixel into an average of pixel values of pixels included in the circular kernel.

In this blurring processing, a filter radius of an averaging filter (a radius of a circular kernel) can be used as the blurring intensity. A larger filter radius results in a higher blurring intensity, and a smaller filter deformation results in a lower blurring intensity.

This blurring processing also makes it possible to simulate a blur based on a depth of field (DoF) of a lens in the real world. Further, the settings of the blurring intensity as illustrated in FIGS. 16 and 17 can be performed.

This blurring processing is processing of calculating a pixel value for each pixel. Thus, there is a possibility that a rendering resolution for the non-gaze object 41 will not be reduced. However, a data amount can be reduced. This makes it possible to improve the efficiency in encoding performed by the encoder 37 situated on the output side.

Reduction of a color component may be performed as data amount reducing processing. In other words, the number of kinds of representable colors may be reduced. For example, a region that corresponds to a portion of the non-gaze object 41 in the region 29 of interest is represented in one color that is gray or a primary color of the region. This makes it possible to reduce a data amount of the non-gaze object 41.

Of course, the blurring processing and the deletion of a color component may be performed in combination. Moreover, any data amount reducing processing may be performed.

As described above, in the server-side rendering system 1 according to the present embodiment, the server apparatus 4 sets the region 29 of interest and the region 30 of non-interest in the display region 31 in which rendering-target two-dimensional video data is displayed. Then, the gaze object 40 in the region 29 of interest is rendered at a high resolution, and a data amount of the non-gaze object 41 in the region 29 of interest is reduced. This makes it possible to distribute a high-quality virtual video.

In the present embodiment, foveated rendering is performed to set, in the viewport (the display region) 31, the region 29 of interest to be rendered at a high resolution and the region 30 of non-interest to be rendered at a low resolution. This makes it possible to reduce rendering processing burdens, and this is advantageous in performing operation in real time. In the foveated rendering, a region is divided regardless of the details of a display image or a shape of an object in the image. Thus, in terms of compression coding performed on an image, a surrounding region (the non-gaze object 41) that is a region other than a region corresponding to the gaze object 40 at which the user 5 is gazing is also rendered at a high resolution.

There is a method for setting, when the encoder 37 situated on the output side renders the region 29 of interest, a parameter to a small value, in order to reduce a degradation in image quality that is caused due to compression coding, the parameter being used to specify the quality that is, for example, a constant rate factor (CRF).

However, encoding with a small CRF value results in a large amount of occurring bits. When compression coding is performed with a small CRF value with respect to the region 29 of interest, a region that has a large information amount from the beginning is encoded at a low compression rate. Thus, an amount of bits occurring in the region 29 of interest accounts for a dominant proportion of an amount of bits occurring in the entirety of an image. This results in increasing a bit rate for the entirety of the image. An increase in a compression rate in the encoder results in a reduction in bit rate. However, this also results in a reduction in image quality in general.

In the present embodiment, the gaze object 40 in the region 29 of interest is extracted to be rendered at a high resolution. Further, data amount reducing processing is performed on the non-gaze object 41 in the region 29 of interest, and a data amount is reduced.

This makes it possible to efficiently reduce a data amount in the region 29 of interest without a loss in subjective image quality. This makes it possible to suppress an amount of occurring bits while maintaining an image quality of the region 29 of interest without making a CFR value smaller. In other words, this makes it possible to reduce a substantial compression rate in the encoder situated on the output side, and to suppress a reduction in image quality and reduce a bit rate at the same time.

As described above, the present embodiment makes it possible to reduce rendering processing burdens (that is, to perform operation in real time), and to suppress a degradation in image quality that is caused due to encoding being performed in real time.

Further, the adoption of the server-side rendering system 1 makes it possible to, for example, control, for each object, a data amount before encoding, without image analysis that imposes heavy processing burdens. This makes it possible to improve the efficiency in encoding an outgoing bitstream.

Note that, when blurring processing is performed as data amount reducing processing, the non-gaze object 41 is blurred. Even if the non-gaze object 41 gets blurred, there is not a significant change in the number of pixels forming the non-gaze object 41.

Thus, there is no change in a data rate calculated from the number of pixels, but an occurring data amount in a blurred region is made smaller than a data amount before blurring of the region. The reason is that, in compression coding, a string of coefficients is short when discrete cosine transform (DCT) is performed to perform quantization with respect to the blurred region. A frequency component of a high spatial frequency is removed from the blurred region, and thus a substantial data amount is reduced.

In the present disclosure, the reduction of a data amount includes such a reduction of a substantial data amount.

It can be said that foveated rendering and blurring processing are both processing of reducing a data amount. On the other hand, the foveated rendering reduces a data amount using a position of an image in a two-dimensional plane as a parameter, whereas the blurring processing reduces a data amount using, as a parameter, a distance from a location of a user to each object. The ways of thinking about the reduction of a data amount are different.

In the present embodiment, blurring processing using the depth map 33 is adopted in the server-side rendering system 1 performing foveated rendering, in order to reduce a data amount of an object other than the gaze object 40 in the region 29 of interest. This results in providing an effect of suppressing a reduction in subjective image quality upon performing compression coding on the region 29 of interest and reducing an occurring bit amount at the same time.

Of course, the application of the present technology is not limited to the adoption of blurring processing using the depth map 33.

### OTHER EMBODIMENTS

The present technology is not limited to the embodiments described above, and can achieve various other embodiments.

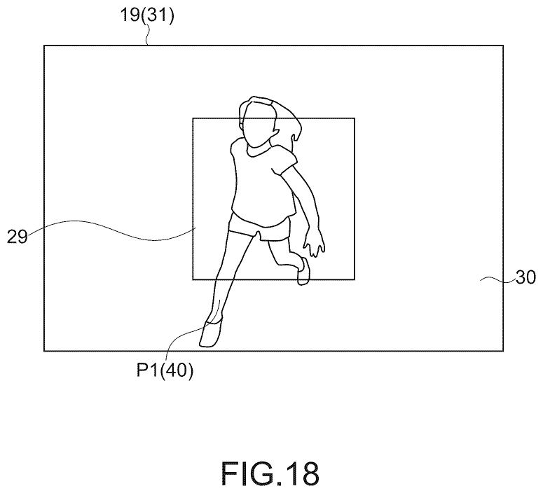

FIG. 18 schematically illustrates an example of rendering according to another embodiment.

When a portion of the gaze object 40 is situated in the region 30 of non-interest, as illustrated in FIG. 18, the portion of the gaze object 40 that is situated in the region 30 of non-interest may be rendered at a high resolution.

In other words, the entirety of the person P1 corresponding to the gaze object 40 (including a portion situated in the region 30 of non-interest) may be rendered at a high resolution.

When fixed foveated rendering is adopted, the region 29 of interest is fixed. Thus, a portion of the gaze object 40 may be situated beyond the region of interest. When, for example, the gaze object 40 is large in size, a portion of the gaze object 40 may be situated beyond the region of interest even if the region 29 of interest is dynamically set according to a gaze point.

When a portion of the gaze object 40 in the region 29 of interest is situated in the region 30 of non-interest (a low-resolution region), as described above, the gaze object 40 including the portion is rendered at a high resolution. This makes it possible to prevent the user 5 gazing the gaze object 40 from seeing a low-resolution portion of the gaze object 40 when the user 5 moves his/her line of sight.

With respect to the example illustrated in FIG. 18, it is possible to prevent the resolution for a portion situated higher than a forehead of the person P1 from being sharply reduced and to prevent the user 5 from feeling uncomfortable.

Further, when the fixed foveated rendering is adopted in particular, there is a need to make the region 29 of interest (a high-resolution region) larger in order to have a margin for movement of a line of sight of the user 5. This results in an increase in a data amount of the region 29 of interest.

The region 29 of interest can be made smaller in size by the rendering illustrated in FIG. 18 being performed. This makes it possible to reduce a data amount of the region 29 of interest. This results in being advantageous in reducing rendering processing burdens and in suppressing a degradation in image quality that is caused due to encoding being performed in real time.

As described above, the present embodiment makes it possible to accurately grasp a contour of the gaze object 40 on the basis of an accurate depth map 33 that is acquired as rendering information. This is very advantageous in performing the rendering illustrated in FIG. 18.

The example in which a full 360-degree spherical video 6 (a 6-DoF video) including, for example, 360-degree space video data is distributed as a virtual image, has been described above. Without being limited thereto, the present technology can also be applied when, for example, a 3DoF video or a 2D video is distributed. Further, not a VR video but, for example, an AR video may be distributed as a virtual image.

Furthermore, the present technology can also be applied to a stereo video (such as a right-eye image and a left-eye image) used to view a 3D image.

FIG. 19 is a block diagram illustrating an example of a hardware configuration of a computer 60 (an information processing apparatus) by which the server apparatus 4 and the client apparatus 3 can be implemented.

The computer 60 includes a CPU 61, a read only memory (ROM) 62, a RAM 63, an input/output interface 65, and a bus 64 through which these components are connected to each other. A display section 66, an input section 67, a storage 68, a communication section 69, a drive 70, and the like are connected to the input/output interface 65.

The display section 66 is a display device using, for example, liquid crystal or EL. Examples of the input section 67 include a keyboard, a pointing device, a touch panel, and other operation apparatuses. When the input section 67 includes a touch panel, the touch panel may be integrated with the display section 66.

The storage 68 is a nonvolatile storage device, and examples of the storage 68 include an HDD, a flash memory, and other solid-state memories. The drive 70 is a device that can drive a removable recording medium 71 such as an optical recording medium or a magnetic recording tape.

The communication section 69 is a modem, a router, or another communication apparatus that can be connected to, for example, a LAN or a WAN and is used to communicate with another device. The communication section 69 may perform communication wirelessly or by wire. The communication section 69 is often used in a state of being separate from the computer 60.

Information processing performed by the computer 60 having the hardware configuration described above is performed by software stored in, for example, the storage 68 or the ROM 62, and hardware resources of the computer 60 working cooperatively. Specifically, the information processing method according to the present technology is performed by loading, into the RAM 63, a program included in the software and stored in the ROM 62 or the like and executing the program.

For example, the program is installed on the computer 60 through the recording medium 61. Alternatively, the program may be installed on the computer 60 through, for example, a global network. Moreover, any non-transitory computer-readable storage medium may be used.

The information processing method and the program according to the present technology may be executed and the information processing apparatus according to the present technology may be implemented by a plurality of computers communicatively connected to each other through, for example, a network working cooperatively.

In other words, the information processing method and the program according to the present technology can be executed not only in a computer system that includes a single computer, but also in a computer system in which a plurality of computers operates cooperatively.

Note that, in the present disclosure, the system refers to a set of components (such as apparatuses and modules (parts)) and it does not matter whether all of the components are in a single housing. Thus, a plurality of apparatuses accommodated in separate housings and connected to each other through a network, and a single apparatus in which a plurality of modules is accommodated in a single housing are both the system.

The execution of the information processing method and the program according to the present technology by the computer system includes, for example, both the case in which the acquisition of field-of-view information, the execution of rendering processing, the generation of rendering information, and the like are executed by a single computer; and the case in which the respective processes are executed by different computers. Further, the execution of the respective processes by a specified computer includes causing another computer to execute a portion of or all of the processes and acquiring a result of it.

In other words, the information processing method and the program according to the present technology are also applicable to a configuration of cloud computing in which a single function is shared and cooperatively processed by a plurality of apparatuses through a network.

The respective configurations of the server-side rendering system, the HMD, the server apparatus, the client apparatus, and the like; the respective processing flows; and the like described with reference to the respective figures are merely embodiments, and any modifications may be made thereto without departing from the spirit of the present technology. In other words, for example, any other configurations or algorithms for purpose of practicing the present technology may be adopted.

In the present disclosure, wording such as “substantially”, “almost”, and “approximately” is used as appropriate in order to facilitate the understanding of the description. On the other hand, whether the wording such as “substantially”, “almost”, and “approximately” is used does not result in a clear difference.

In other words, in the present disclosure, expressions, such as “center”, “middle”, “uniform”, “equal”, “similar”, “orthogonal”, “parallel”, “symmetric”, “extend”, “axial direction”, “columnar”, “cylindrical”, “ring-shaped”, and “annular” that define, for example, a shape, a size, a positional relationship, and a state respectively include, in concept, expressions such as “substantially the center/substantial center”, “substantially the middle/substantially middle”, “substantially uniform”, “substantially equal”, “substantially similar”, “substantially orthogonal”, “substantially parallel”, “substantially symmetric”, “substantially extend”, “substantially axial direction”, “substantially columnar”, “substantially cylindrical”, “substantially ring-shaped”, and “substantially annular”.

For example, the expressions such as “center”, “middle”, “uniform”, “equal”, “similar”, “orthogonal”, “parallel”, “symmetric”, “extend”, “axial direction”, “columnar”, “cylindrical”, “ring-shaped”, and “annular” also respectively include states within specified ranges (such as a range of +/−10%), with expressions such as “exactly the center/exact center”, “exactly the middle/exactly middle”, “exactly uniform”, “exactly equal”, “exactly similar”, “completely orthogonal”, “completely parallel”, “completely symmetric”, “completely extend”, “fully axial direction”, “perfectly columnar”, “perfectly cylindrical”, “perfectly ring-shaped”, and “perfectly annular” being respectively used as references.

Thus, an expression that does not include the wording such as “substantially”, “almost”, and “approximately” can also include, in concept, a possible expression including the wording such as “substantially”, “almost”, and “approximately”. Conversely, a state expressed using the expression including the wording such as “substantially”, “almost”, and “approximately” may include a state of “exactly/exact”, “completely”, “fully”, or “perfectly”.

In the present disclosure, an expression using “-er than” such as “being larger than A” and “being smaller than A” comprehensively includes, in concept, an expression that includes “being equal to A” and an expression that does not include “being equal to A”. For example, “being larger than A” is not limited to the expression that does not include “being equal to A”, and also includes “being equal to or greater than A”. Further, “being smaller than A” is not limited to “being less than A”, and also includes “being equal to or less than A”.

When the present technology is carried out, it is sufficient if a specific setting or the like is adopted as appropriate from expressions included in “being larger than A” and expressions included in “being smaller than A”, in order to provide the effects described above.

At least two of the features of the present technology described above can also be combined. In other words, the various features described in the respective embodiments may be combined discretionarily regardless of the embodiments. Further, the various effects described above are not limitative but are merely illustrative, and other effects may be provided.

Note that the present technology may also take the following configurations.
(1) An information processing apparatus, including
   a rendering section that performs rendering processing on three-dimensional space data on the basis of field-of-view information regarding a field of view of a user to generate two-dimensional video data depending on the field of view of the user,
   the rendering section setting a region of interest and a region of non-interest in a display region in which the two-dimensional video data is displayed, the region of interest being to be rendered at a high resolution, the region of non-interest being to be rendered at a low resolution,
   the rendering section extracting a gaze object at which the user gazes, on the basis of a parameter related to the rendering processing and the field-of-view information,
   the rendering section rendering the gaze object in the region of interest at a high resolution,
   the rendering section reducing a data amount of a non-gaze object that is an object other than the gaze object in the region of interest.
(2) The information processing apparatus according to (1), in which
   the parameter related to the rendering processing includes distance information regarding a distance to a rendering-target object, and
   the rendering section reduces the data amount of the non-gaze object in the region of interest on the basis of the distance information.
(3) The information processing apparatus according to (2), in which the rendering section performs blurring processing on the non-gaze object in the region of interest.
(4) The information processing apparatus according to (3), in which the rendering section simulates a blur based on a depth of field of a lens in a real world to perform the blurring processing.
(5) The information processing apparatus according to (3) or (4), in which
   the rendering section sets a higher blurring intensity for the non-gaze object when a difference between a distance to the non-gaze object and a specified reference distance becomes larger.
(6) The information processing apparatus according to (3) or (4), in which
   the rendering section
      sets a plurality of ranges for a difference between a distance to the non-gaze object and a specified reference distance, and
      sets a blurring intensity for each of the plurality of ranges.
(7) The information processing apparatus according to (6), in which
   the rendering section
      sets a first range in which the difference between the distance to the non-gaze object and the specified reference distance is between zero and a first distance,
      sets a second range in which the difference is between the first distance and a second distance that is larger than the first distance,
      sets a first blurring intensity for the first range, and
      sets, for the second range, a second blurring intensity that is higher than the first blurring intensity.
(8) The information processing apparatus according to (7), in which
   the rendering section
      sets a third range in which the difference is between the second distance and a third distance that is larger than the second distance, and
      sets, for the third range, a third blurring intensity that is higher than the second blurring intensity.
(9) The information processing apparatus according to any one of (3) to (8), in which
   the rendering section sets the blurring intensity such that the non-gaze object situated in a range situated farther away from the user than a location at a specified reference distance is more blurred than the non-gaze object situated in a range situated closer to the user than the location at the reference distance.
(10) The information processing apparatus according to any one of (3) to (9), in which
   the rendering section performs the blurring processing on the non-gaze object after the rendering section renders the non-gaze object at a high resolution.
(11) The information processing apparatus according to any one of (3) to (9), in which
   the rendering section renders the non-gaze object at a resolution to be applied when the blurring processing is performed.
(12) The information processing apparatus according to any one of (1) to (11), in which
   when a portion of the gaze object is situated in the region of non-interest, the rendering section renders the portion of the gaze object in the region of non-interest at a high resolution.
(13) The information processing apparatus according to (1), in which
   the rendering section
      renders the gaze object in the region of interest at a first resolution, and
      renders, at a second resolution, the non-gaze object that is an object other than the gaze object in the region of interest, the second resolution being lower than the first resolution.
(14) The information processing apparatus according to any one of (1) to (13), in which
   the rendering section sets the region of interest and the region of non-interest on the basis of the field-of-view information.
(15) The information processing apparatus according to any one of (1) to (14), further including
   an encoding section that sets a quantization parameter for the two-dimensional video data and performs encoding processing on the two-dimensional video data on the basis of the set quantization parameter.
(16) The information processing apparatus according to (15), in which
   the encoding section
      sets a first quantization parameter for the region of interest, and
      sets, for the region of non-interest, a second quantization parameter that exhibits a larger value than the first quantization parameter.
(17) The information processing apparatus according to (15), in which
   the encoding section
      sets a first quantization parameter for the gaze object in the region of interest,
      sets, for the non-gaze object in the region of interest, a second quantization parameter that exhibits a larger value than the first quantization parameter, and
      sets, for the region of non-interest, a third quantization parameter that exhibits a larger value than the second quantization parameter.
(18) The information processing apparatus according to any one of (1) to (17), in which
   the three-dimensional space data includes at least one of 360-degree-all-direction video data or space video data.
(19) An information processing method that is performed by a computer system, the information processing method including
   performing rendering that is performing rendering processing on three-dimensional space data on the basis of field-of-view information regarding a field of view of a user to generate two-dimensional video data depending on the field of view of the user,
   the performing rendering including
      setting a region of interest and a region of non-interest in a display region in which the two-dimensional video data is displayed, the region of interest being to be rendered at a high resolution, the region of non-interest being to be rendered at a low resolution,
      extracting a gaze object at which the user gazes, on the basis of a parameter related to the rendering processing and the field-of-view information,
      rendering the gaze object in the region of interest at a high resolution, and
      reducing a data amount of a non-gaze object that is an object other than the gaze object in the region of interest.

### REFERENCE SIGNS LIST

1 server-side rendering system
2 HMD
3 client apparatus
4 server apparatus
5 user
6 full 360-degree spherical video
8 rendering video
12 field-of-view information acquiring section
14 rendering section
encoding section
16 communication section
19 frame image
29 region of interest
30 region of non-interest
31 viewport (display region)
33 depth map
35 reproduction section
36 renderer
37 encoder
38 controller
40 gaze object
41 non-gaze object
60 computer

1. An information processing apparatus, comprising
a rendering section that performs rendering processing on three-dimensional space data on a basis of field-of-view information regarding a field of view of a user to generate two-dimensional video data depending on the field of view of the user,
the rendering section setting a region of interest and a region of non-interest in a display region in which the two-dimensional video data is displayed, the region of interest being to be rendered at a high resolution, the region of non-interest being to be rendered at a low resolution,
the rendering section extracting a gaze object at which the user gazes, on a basis of a parameter related to the rendering processing and the field-of-view information,
the rendering section rendering the gaze object in the region of interest at a high resolution,
the rendering section reducing a data amount of a non-gaze object that is an object other than the gaze object in the region of interest.

2. The information processing apparatus according to claim 1, wherein
the parameter related to the rendering processing includes distance information regarding a distance to a rendering-target object, and
the rendering section reduces the data amount of the non-gaze object in the region of interest on a basis of the distance information.

3. The information processing apparatus according to claim 2, wherein
the rendering section performs blurring processing on the non-gaze object in the region of interest.

4. The information processing apparatus according to claim 3, wherein
the rendering section simulates a blur based on a depth of field of a lens in a real world to perform the blurring processing.

5. The information processing apparatus according to claim 3, wherein
the rendering section sets a higher blurring intensity for the non-gaze object when a difference between a distance to the non-gaze object and a specified reference distance becomes larger.

6. The information processing apparatus according to claim 3, wherein
the rendering section
sets a plurality of ranges for a difference between a distance to the non-gaze object and a specified reference distance, and
sets a blurring intensity for each of the plurality of ranges.

7. The information processing apparatus according to claim 6, wherein
the rendering section
sets a first range in which the difference between the distance to the non-gaze object and the specified reference distance is between zero and a first distance,
sets a second range in which the difference is between the first distance and a second distance that is larger than the first distance,
sets a first blurring intensity for the first range, and
sets, for the second range, a second blurring intensity that is higher than the first blurring intensity.

8. The information processing apparatus according to claim 7, wherein
the rendering section
sets a third range in which the difference is between the second distance and a third distance that is larger than the second distance, and
sets, for the third range, a third blurring intensity that is higher than the second blurring intensity.

9. The information processing apparatus according to claim 3, wherein
the rendering section sets the blurring intensity such that the non-gaze object situated in a range situated farther away from the user than a location at a specified reference distance is more blurred than the non-gaze object situated in a range situated closer to the user than the location at the reference distance.

10. The information processing apparatus according to claim 3, wherein
the rendering section performs the blurring processing on the non-gaze object after the rendering section renders the non-gaze object at a high resolution.

11. The information processing apparatus according to claim 3, wherein
the rendering section renders the non-gaze object at a resolution to be applied when the blurring processing is performed.

12. The information processing apparatus according to claim 1, wherein
when a portion of the gaze object is situated in the region of non-interest, the rendering section renders the portion of the gaze object in the region of non-interest at a high resolution.

13. The information processing apparatus according to claim 1, wherein
the rendering section
renders the gaze object in the region of interest at a first resolution, and
renders, at a second resolution, the non-gaze object that is an object other than the gaze object in the region of interest, the second resolution being lower than the first resolution.

14. The information processing apparatus according to claim 1, wherein
the rendering section sets the region of interest and the region of non-interest on the basis of the field-of-view information.

15. The information processing apparatus according to claim 1, further comprising
an encoding section that sets a quantization parameter for the two-dimensional video data and performs encoding processing on the two-dimensional video data on a basis of the set quantization parameter.

16. The information processing apparatus according to claim 15, wherein
the encoding section
sets a first quantization parameter for the region of interest, and
sets, for the region of non-interest, a second quantization parameter that exhibits a larger value than the first quantization parameter.

17. The information processing apparatus according to claim 15, wherein
the encoding section
sets a first quantization parameter for the gaze object in the region of interest,
sets, for the non-gaze object in the region of interest, a second quantization parameter that exhibits a larger value than the first quantization parameter, and
sets, for the region of non-interest, a third quantization parameter that exhibits a larger value than the second quantization parameter.

18. The information processing apparatus according to claim 1, wherein
the three-dimensional space data includes at least one of 360-degree-all-direction video data or space video data.

19. An information processing method that is performed by a computer system, the information processing method comprising
performing rendering that is performing rendering processing on three-dimensional space data on a basis of field-of-view information regarding a field of view of a user to generate two-dimensional video data depending on the field of view of the user,
the performing rendering including
setting a region of interest and a region of non-interest in a display region in which the two-dimensional video data is displayed, the region of interest being to be rendered at a high resolution, the region of non-interest being to be rendered at a low resolution,
extracting a gaze object at which the user gazes, on a basis of a parameter related to the rendering processing and the field-of-view information,
rendering the gaze object in the region of interest at a high resolution, and
reducing a data amount of a non-gaze object that is an object other than the gaze object in the region of interest.
